(19) United States
(12) Patent Application Publication
(10) Pub. No.: US 2026/0168473 A1
(43) Pub. Date: Jun. 18, 2026

(54) ADJUSTABLE ATOMIZING FUEL INJECTOR ASSEMBLY

(71) Applicant: Donald John JACKSON, Oceanside, CA (US)

(72) Inventor: Donald John JACKSON, Oceanside, CA (US)

(21) Appl. No.: 18/984,996

(22) Filed: Dec. 17, 2024

(51) Int. Cl. F02M 61/18; F02M 61/16

(52) U.S. Cl. CPC F02M 61/1806; F02M 61/168; F02M 2200/8069

(57) ABSTRACT

An adjustable atomizing fuel injector assembly has a main body with an upstream end longitudinally opposite a downstream end, the upstream end connectable to a fuel rail. An internal channel extends longitudinally through the main body to a jet formed at the downstream end. A deflecting structure extends from the downstream end and includes an open-sided channel in fluid communication with the jet. An adjustable atomizer having a threaded base and an impact pin engages the deflecting structure to allow for variable penetration of the impact pin into the open-sided channel to form an air gap of variable length between the impact pin and the jet. The proximal end of the impact pin can be positioned upstream, downstream, or coincident with the vena contracta of fuel flow exiting the jet to atomize the fuel.

### BACKGROUND OF THE INVENTION

### Field of the Invention

The present invention relates generally to fuel injector assemblies, and more specifically to an atomizing fuel injector assembly for supercharger engines.

### Description of Related Art

Supercharger design and principles of operation are well-known. Generally, superchargers increase the pressure or density of air supplied to an internal combustion engage to give each intake cycle of the engine more oxygen, thereby increasing power. Drag racing engines are a common application for superchargers.

One known design for superchargers used in drag racing has a hollow shaft or tube having multiple outlets spaced along the length of the tube and facing the air intake manifold of the supercharger. Each of the outlets is fixed with a specialized adjustable atomizer, so that atomized fuel exiting the outlets disperses throughout a greater volume of the air when entering the manifold. The fuel is typically supplied by a positive displacement gear pump driven directly off the cam shaft of the engine. This design is suitable for methanol or nitromethane engines that demand a fuel flow rate of up to 10,000 lb/hr sufficient to atomize the fuel.

Atomizers are designed to accelerate, and then interfere with, the flow of fuel exiting the nozzle, to create a more homogeneous dispersion of the atomized fuel when it mixes with air. Generally, adjustable atomizers are designed with a baffle or other deflecting structure disposed a short distance from the nozzle outlet. The deflecting structure provides an impact surface to effect the interference and dispersal of the atomized fuel. A known problem with these existing adjustable atomizers, however, is that fuel can build up at the impact surface, reducing the overall efficiency of the engine. The fuel collides with the deflecting structure, causing some of the fuel to reliquefy and drip away from the manifold.

There have been previous attempts to design atomizers that avoid the fuel build up problem. However, these atomizers are notoriously difficult to manufacture. One such prior attempt can be found in the inventor's previous patent, U.S. Pat. No. 10,406,540. The '540 patent provided an atomizer design that overcame the problem of fuel build up but still proved difficult to manufacture and limited the options available to the operator for experimentation with performance. The prior design required a specially manufactured deflecting structure that required very precise machining operations to form an integral impact pin extending from the deflecting structure. The machining operation for this prior design required concentric conical holes to be machined into opposing sides to form a pedestal with an integral impact pin extending from the pedestal. A high degree of precision is required in the machining operations to form this prior design, which increased overall manufacturing costs. Also, the impact pin and the deflecting structure were machined from a single piece of metal, so whenever an operator wanted to change pin sizes to experiment with the performance of their dragster, this required removal and replacement of the entire atomizer.

Thus, what is needed is an improved design for atomizing fuel injector assemblies that can more easily be manufactured and provides an operator with the ability to make quick adjustments to the injector assembly to optimize engine performance.

### SUMMARY OF THE INVENTION

The present invention relates to atomizing fuel injector assemblies that are easier to manufacture and install than previous designs. The atomizing fuel injector assembly according to the present invention includes a main body that is integrated with a deflecting structure. An atomizer is removably engaged through the deflecting structure, and its linear position within the deflecting structure can be adjusted, thereby allowing an operator to fine-tune the placement of the atomizer, or easily replace the atomizer, and therefore more conveniently experiment with engine optimization.

In one embodiment, the atomizing fuel injector assembly includes a main body having a first end and a second end with an internal channel extending therebetween. With respect to a longitudinal axis of the main body, the first and second ends are opposite one another, each located at a longitudinal end of the internal channel. With respect to fuel flow, the first end is upstream of the second end. A jet is formed in the internal channel at the second end of the main body. A deflecting structure extends from the second end and forms an open-sided channel. The jet directs fuel into the open-sided channel. An adjustable atomizer, having a base and an impact pin extending from the base, engages through the deflecting structure and extends into the open-sided channel toward the jet. The degree of engagement of the atomizer within the deflecting structure is adjustable, so that displacement of the impact pin from the jet can be adjusted with precision.

The deflecting structure is preferably constructed of opposing baffles and a pedestal, with the opposing baffles extending from the second end toward the pedestal. The pedestal preferably integrally connects to each of the baffles. The open-sided channel is defined between the opposing baffles. In some embodiments, at least one of the baffles is tapered. In some embodiments, one or both of the baffles have a triangular cross-section.

In preferred embodiments, an internally threaded aperture is defined through the pedestal. The adjustable atomizer is configured to engage through this aperture. Preferably, the base of the adjustable atomizer has external threads complimentary to the internal threads present in the aperture to allow threaded engagement of the adjustable atomizer and the deflecting structure. Preferably, when the adjustable atomizer is engaged through the deflecting structure, an air gap is formed between a distal end of the jet and a proximal end of the impact pin. The adjustable atomizer also includes a means for adjusting the size of the air gap. The air gap adjustment means may include a socket defined in the distal end of the adjustable atomizer base, which allows an operator, using an appropriate driving tool, to adjust the degree of engagement between the adjustable atomizer and the deflecting structure to thereby adjust the size of the air gap. In some embodiments, the socket is a hexagonal socket designed to engage a hex key or other type of socket wrench. In one embodiment, the span of adjustment of the air gap allows for an air gap setting from about 0.0165 inches to about 0.0175 inches. Preferably, the degree of engagement of the adjustable atomizer allows an operator to place the proximal end of the impact pin upstream, downstream, or coincident with the vena contracta of the fuel flow. In some embodiments, the outer diameter of the impact pin is greater than the inner diameter of the jet.

In alternative embodiments, the present invention relates to a method for manufacturing an adjustable atomizing fuel injector assembly. The assembly includes a main body having a first end and a second end with an internal channel extending longitudinally therebetween. With respect to a longitudinal axis of the main body, the first and second ends are opposite one another, each located at a longitudinal end of the internal channel, and with respect to fuel flow, the first end is upstream of the second end. The first end includes a means for connecting the main body to a fuel rail. A jet is formed in the channel at the second end of the main body. The method includes machining a deflecting structure in the second end of the main body, downstream from the jet. Internal threads are machined through the distal end of the deflecting structure. The next step requires forming the adjustable atomizer, which has a base and an impact pin extending forward from the base. The adjustable atomizer is configured to engage through the deflecting structure. Preferably, the base is formed with external threads that are complimentary to the internal threads defined through the deflecting structure.

In some embodiments, the method includes a step for machining opposing baffles so that the opposing baffles extend from the second end of the main body toward a machined pedestal formed at a distal end of the main body. The internally threaded aperture is defined through the pedestal. The machined baffles preferably partially enclose a channel that is concentrically aligned between the distal end of the jet and the aperture in the pedestal.

The final step involves assembling the atomizing fuel injector assembly by threadably engaging the formed adjustable atomizer through the deflecting structure. This forms an air gap between the distal end of the jet and the proximal end of the impact pin, which air gap is adjustable by adjusting the degree of engagement of the adjustable atomizer within the deflecting structure. Preferably, the air gap is adjustable so that the proximal end of the impact pin may be positioned before, after, or coincident with the vena contracta of the fuel flow.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a perspective view of a first embodiment of an adjustable atomizing fuel injector assembly according to the present invention.

FIG. 2 is a perspective view of an embodiment of a main body of an adjustable atomizing fuel injector assembly according to the present invention.

FIG. 3 is a partially transparent side view of an embodiment of the adjustable atomizing fuel injector assembly according to the present invention.

FIG. 4 is an exploded, partially transparent side view of an embodiment of an adjustable atomizing fuel injector assembly according to the invention.

FIG. 5 is a magnified perspective view of an embodiment of an adjustable atomizer that forms part of the atomizing fuel injector assembly according to the invention.

FIG. 6 is a partially transparent side view of an embodiment of the adjustable atomizing fuel injector assembly.

FIG. 7 is a perspective view of an embodiment of a locking nut of an atomizing fuel injector assembly according to the invention.

FIG. 8 is a partially transparent side view of an embodiment of the main body of the atomizing fuel injector assembly according to the invention.

FIG. 9 is a second partially transparent side view of the main body, rotated 90-degrees from the view of FIG. 8.

FIG. 10 is a left end view of the main body of FIG. 8.

FIG. 11 is a cross-sectional end view, taken along lines A-A marked in FIG. 9, of an embodiment of the main body according to the invention.

FIG. 12 is a right end view of the main body of FIG. 9.

FIG. 13 is a cross-sectional side view, taken along lines B-B marked in FIG. 10, of an embodiment of the main body according to the invention.

### DETAILED DESCRIPTION OF THE INVENTION

The following disclosure presents exemplary embodiments of an adjustable atomizing fuel injector assembly. The adjustable atomizing fuel injector assembly according to the present invention has a simpler construction than previous fuel injector assemblies, which reduces the manufacturing time and cost per assembly. Further, fuel injector assemblies according to the present invention allow for incremental adjustment of the air gap between the jet and the impact pin to allow the operator to make quick adjustments to optimize fuel efficiency.

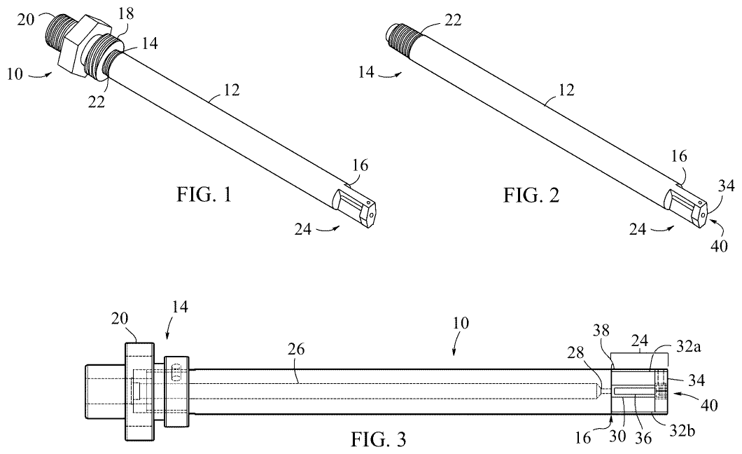

FIG. 1 is a perspective view of a first embodiment of an adjustable atomizing fuel injector assembly according to the present invention. The adjustable atomizing fuel injector assembly (hereinafter, just atomizing assembly or fuel injector assembly) 10 includes a main body 12 having a first end 14 and second end 16, which is downstream and longitudinally opposite from the first end 14. The first end 14 includes a means 18 for connecting the main body 12 to an upstream fuel rail, as is known in the relevant art. The connection means 18 preferably includes a removable locking nut 20 threadably engaged to threads 22 formed around the outer surface of the first end 14 of the main body 12. FIG. 2 is a perspective view of an embodiment of the main body with the locking nut 20 removed, exposing the threads 22 at the first end 14. Extending forward from the second end 16 of the main body 12 is a deflecting structure 24, which has an aperture 40 configured to receive an adjustable atomizer 36 therethrough.

FIG. 3 is a partially transparent side view of an embodiment of an atomizing assembly 10 according to the present invention. The main body 12 has an internal channel 26 extending from the first end 14 to the second end 16. The second end 16 includes a jet 28 fluidically connected to the internal channel 26. The jet 28 opens or feeds into an open-sided channel 30 formed within the deflecting structure 24. Two baffles 32a, 32b extend from the second end 16 to partially enclose the channel 30 within the deflecting structure 24. A pedestal 34 is formed at the distal end of the deflecting structure 24 and is integrally connected to each baffle 32a, 32b. An adjustable atomizer 36 is engaged through the aperture 40 defined in the pedestal 34. In preferred embodiments, an air gap 38 is created and maintained between the distal end of the jet 28 and the proximal end of the adjustable atomizer 36 when it is engaged through the deflecting structure 24.

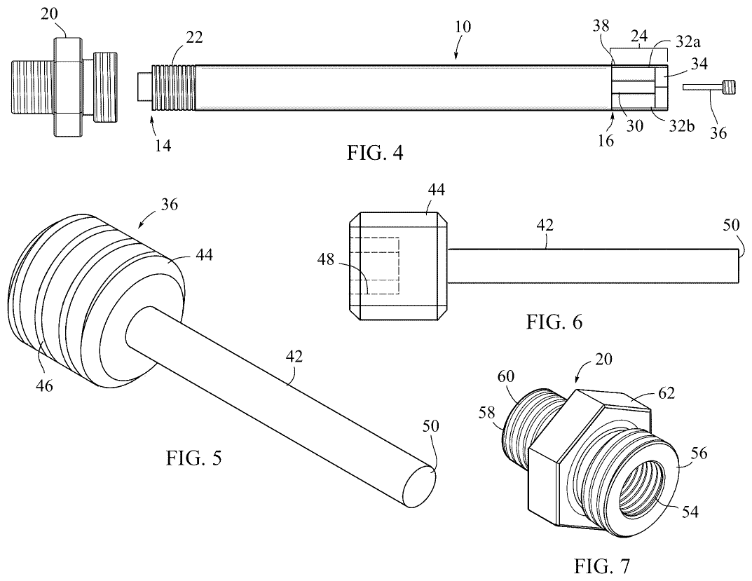

FIG. 4 is an exploded side view of an embodiment of an atomizing assembly 10 according to the present invention. The deflecting structure 24 includes the baffles 32a, 32b extending from the second end 16 to the pedestal 34. The aperture 40 defined through the distal end of the pedestal 34 opens into the channel 30 formed between the baffles 32a, 32b. The adjustable atomizer 36 has an impact pin 42 extending from a base 44. The base 44 preferably includes external threads 46 configured to engage complimentary threads in the aperture 40 of the pedestal. The adjustable atomizer 36 is removably engaged through the deflecting structure 24. When the adjustable atomizer is installed within the deflecting structure 24, the air gap 38 is created between the jet 28 and the proximal end of the impact pin 42. The air gap 38 can therefore be adjusted, or set by an operator, by threading the adjustable atomizer 36 to a desired linear position within the deflecting structure 24.

In preferred embodiments, a concentric alignment is created between each of the outlet of the jet 28, the channel 30, and the aperture 40. The concentricity between each of the outlet of the jet 28, the channel 30, and the aperture 40 ensures proper alignment of the impact pin 42 when the adjustable atomizer 36 is engaged through the deflecting structure 24. In other words, the channel 30, the aperture 40, and the outlet of the jet 28 are preferably axially aligned.

The jet 28 increases the relative velocity of fuel supplied to the fuel injector assembly 10. The jet 28 is constructed to cause what is known in fluid dynamics as a vena contracta, which is a point in the fluid flow exiting the jet where the diameter of the fluid stream is less than the diameter of the jet outlet. The fluid velocity at the vena contracta is at its maximum while the diameter of the fluid stream is at its minimum. Generally speaking, in dragster engines, high-velocity fuel flow through the fuel injector creates a Reynolds Number sufficiently high so that the vena contracta is determined by the geometry of the outlet of the jet, in this case, jet 28. In preferred embodiments, the jet 28 is constructed so that its outlet has sharp edges, e.g., 90-degree corners, which generate a vena contracta according to well-known principles of fluid dynamics.

In preferred embodiments, the adjustable atomizer 36 is configured to allow adjustment of the placement of impact pin 42 along a linear axis so that the proximal end of the impact pin 42 can be positioned upstream, downstream, or coincident with the vena contracta created by the jet 28. The linear axis along which the impact pin may be adjusted is preferably coincident with the longitudinal axis of the main body 12 and internal channel 26. To ensure the proximal end of the impact pin 42 is properly positioned, an operator may adjust the size of the air gap 38 by adjusting the linear position of the impact pin 42 within the deflecting structure 24. Placement of the proximal end of the impact pin 42 at or near the point of vena contracta optimizes fuel atomization and dispersion, thereby increasing efficiency of the fuel injector assembly 10.

In some preferred embodiments, the outer diameter of the impact pin 42 is greater than the diameter of the jet 28 at the jet outlet. In one example, the jet 28 has a diameter equal to about 0.003 inches at the outlet whereas the impact pin 42 has an outer diameter between about 0.0033 inches and about 0.0034 inches.

FIG. 5 is a perspective view of an embodiment of an adjustable atomizer according to the present invention. As stated briefly above, the adjustable atomizer 36 preferably has a base 44 formed with external threads 46 that are complimentary to the internal threads defined in the aperture 40 of the pedestal 34. The impact pin 42 is preferably cylindrical and extends from the base 44. Geometrical shapes of impact pins other than cylindrical are possible without departing from the scope of invention, e.g., linear bars having rectangular, triangular, oval, hexagonal, and trapezoidal cross-sections. Whatever its geometry, the adjustable atomizer 36 is designed so that threaded engagement of the atomizer 36 through the pedestal 34 of the deflecting structure 24 creates an air gap 38 between the distal or outlet end of the jet 28 and the proximal end 50 of the impact pin.

The means for adjusting the size of the air gap 38 may include the external threads 46 of the base 44 and the complimentary internal threads of the deflecting structure 24. In addition, the adjusting means in one embodiment may also include a stop (not shown) formed in either the internal or external threading, that functions to arrest the linear movement of the impact pin 42 in the proximal or upstream direction. Preferably, the stop arrests movement of the impact pin at a point where the proximal end 50 lies between the outlet of the jet and the vena contracta. At that stopping point, the adjustable atomizer has been moved to its maximum proximal position and is said to be fully engaged within the deflecting structure.

FIG. 6 is a partially transparent side view of an embodiment of the adjustable atomizer 36. The base 44 of the adjustable atomizer 36 includes a socket 48 defined in the distal end. The socket 48 may form a part of the means for adjusting the size of the air gap 38. In one embodiment the socket 48 is a hexagonal socket. An operator may use a driving tool that is configured to engage the socket, to drive the atomizer 36 along its linear axis of travel in either the distal or proximal direction. The operator may thereby easily install an adjustable atomizer 36 through the pedestal 34 of the deflecting structure 24. After installation, an operator using a driving tool in socket 48 can set the air gap 38 to a desired distance by making incremental adjustments to the linear position of the impact pin 42 within the deflecting structure 24. The same means can be used to easily remove and replace an atomizer 36.

FIG. 7 is an isolated perspective view of an embodiment of a locking nut that may be used in the fuel injector assembly according to the present invention. The locking nut 20 forms part of the connection means 18 and includes internal threads 54 formed at a first end 56, which internal threads 54 are complimentary to threads 22 formed at the first end 14 of the main body 12. The opposite second end 58 includes external threads 60 that are complimentary to threads found on a fuel rail. An external nut 62 allows an operator to adjust connection of the fuel injector assembly to the fuel rail, to ensure that a tight fluid seal is maintained at each connection point.

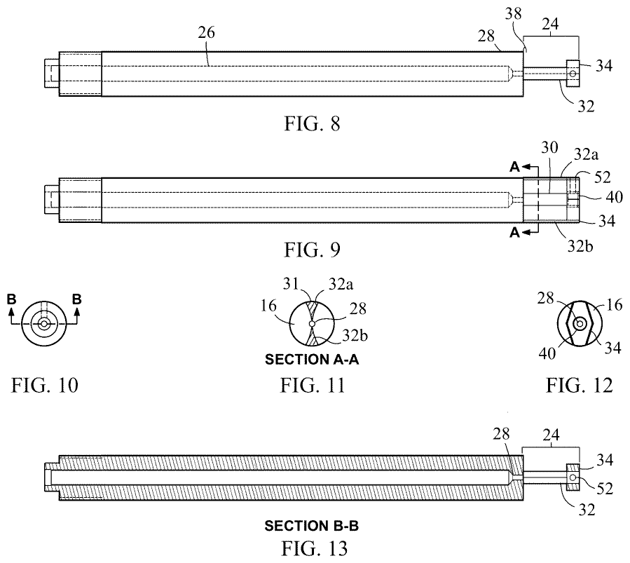

FIG. 8 is a side view of an embodiment of the main body 12 according to the present invention. FIG. 9 is a second side view of the main body 12 rotated substantially 90-degrees from the view of FIG. 8. In both FIGS. 8 and 9, the internal channel 26 is shown in phantom lines. The aperture 40 is defined through the pedestal 34 and shown in phantom lines. The aperture 40 is preferably concentrically aligned with the jet 28 and the channel 30, as described above. The aperture 40 is configured to receive the adjustable atomizer 36 therethrough. In preferred embodiments, the aperture 40 is internally threaded with threads complimentary to the external threads 46 formed on the base 44 of the adjustable atomizer 36.

FIG. 11 is a cross-sectional right end view, taken along lines A-A of FIG. 9, of an embodiment of the main body 12 according to the present invention. This view illustrates one embodiment of baffles 32a and 32b, which are preferably integrally formed on the deflecting structure 24. In some embodiments, one or both baffles 32a and 32b are tapered, from a minimal cross-section near the channel 30 to a wider cross-section that expands radially.

FIG. 10 is an end view of an embodiment of the main body 12 according to the present invention. FIG. 13 is a cross-sectional side view, taken along lines B-B of FIG. 10, of the main body 12. The view of FIG. 9 shows an embodiment of the pedestal 34 in which a secondary aperture 52 is defined through an outer side of at least one of the baffles 32a or 32b. The secondary aperture 52 extends into the aperture 40, as depicted in FIG. 9, where the secondary aperture 52 is shown in phantom lines near the distal end of baffle 32a. The secondary aperture 52 is configured to receive a pin or set screw that will contact and arrest the base 44 of the adjustable atomizer 36 when the atomizer 36 is engaged through the pedestal 34. When an operator is satisfied with the position of the impact pin 42, the operator may lock the atomizer 36 into position by inserting the set screw to prevent undesired axial movement of the impact pin 42, e.g., due to vibration during engine operation.

FIG. 12 is an end view, taken from the second end looking back toward the first end, of an embodiment of the main body 12 of a fuel injector assembly according to the present invention. FIG. 12 illustrates the concentricity among the aperture 40 and the outlet of the jet 28. The channel 30 extends concentrically between the aperture 40 and the jet 28.

Manufacture of the atomizing fuel injector assembly 10 is greatly improved by the present invention. In preferred embodiments, computer numerical control (“CNC”) machining is utilized to precisely form the atomizing fuel injector assembly 10. The main body 12 may be machined from a cylindrical metal rod, such as a brass or other metal commonly used for pipe fittings that conduct pressurized fluids. In one example, C360 brass may be used. The length of the starting rod in one example is about 3.962 inches. The internal channel 26 is machined through the main body 12 from the first end 14 to the second end 16, where the jet 28 is similarly machined therein. The jet 28 is preferably formed with sharp edges at the outlet, In one example, the outlet has a diameter equal to about 0.033 inches. Threads 22 may be machined onto the outer surface of the first end 14 and are complimentary to threads 54 present in the locking nut 20. In one example, the length between the first end 14 and the second end 16 is equal to about 3.544 inches, and the remaining material extending from the second end 16 may be utilized to form the deflecting structure 24. In one example, about 0.5 inches of unfinished material extends from the second end 16 and is sufficient to form the deflecting structure.

Once the basics of the main body 12 have been machined from the starting cylindrical rod, the deflecting structure 24 is thereafter machined to extend forward from the second end 16. The channel 30 may be formed as a byproduct of the machining operations that make the baffles 32a, 32b. Preferably, the deflecting structure 24 is machined from opposing sides, tapering each baffle 32a and 32b from the outer surface 31 inward. In one embodiment, the length of the baffles 32a, 32b extending from the second end 16 is preferably about 0.318 inches and the width at the outer surface 31 of each baffle 32a and 32b is between about 0.093 inches and about 0.095 inches. The pedestal 34 may be similarly formed as a byproduct of the machining operation that makes the baffles 32a, 32b. Preferably, the pedestal 34 extends substantially about 0.100 inches from the distal ends of the baffles 32a, 32b. Once the deflecting structure 24 is substantially machined from the second end 16, the internally threaded aperture 40 may be machined through the distal end of the pedestal 34. Precision machining of the aperture 40 is needed to ensure that concentric alignment is created and maintained between each of the aperture 40, the jet 28, and the channel 30. Loss of concentricity among the aperture 40, the jet 28 and the channel 30 can have detrimental effects on the performance of the atomizing fuel injector assembly 10.

The adjustable atomizer 36 may be formed from a material similar to that of the main body 12, e.g., C360 brass. The threads 46 may be machined into the base 44 of the adjustable atomizer 36, and thereafter, the impact pin 42 may be machined to extend from the base 44. Preferably, the outer diameter of the impact pin 42 is about 0.033 inches to about 0.034 inches. The length of the impact pin 42 extending from the base 44 may be about 0.300 inches whereas the total length of the adjustable atomizer 36 may be about 0.400 inches.

With the component parts of the atomizing fuel injector assembly 10 manufactured, the final step requires assembling of the parts. The adjustable atomizer 36 is engaged through the deflecting structure via threaded engagement between the internal threads of the aperture 40 and the external threads 46 on the base 44. Using a driver engaged into the socket 48 that is defined in the base 44, an operator can adjust the placement of the adjustable atomizer 36 within the deflecting structure 24 to achieve a desired air gap 38 as described above. In one embodiment, full engagement of the adjustable atomizer 36 through the deflecting structure 24 positions the proximal end 50 of the impact pin 42 at or near the vena contracta of the fuel flow. In another embodiment, when desired placement of the impact pin is achieved, the set screw is installed into aperture 52 to lock the atomizer 36 into position.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. An atomizing fuel injector assembly, comprising:
a main body having a first end, a second end, an internal channel extending between the first end and the second end, a jet formed in the channel at the second end, and a deflecting structure extending from the second end, the deflecting structure forming an open-sided channel, and the jet having an outlet axially aligned with the open-sided channel; and
an adjustable atomizer having a base and an impact pin extending from the base, and configured for adjustable engagement within the deflecting structure so that the impact pin when extended through the deflecting structure into the open-sided channel forms an adjustable gap between a proximal end of the impact pin and the outlet of the jet.

2. The assembly of claim 1, wherein the deflecting structure comprises opposing baffles extending from the second end toward a pedestal, the pedestal integrally connected to each opposing baffle.

3. The assembly of claim 2, wherein the open-sided channel is defined between the opposing baffles.

4. The assembly of claim 2, wherein at least one of the opposing baffles is tapered.

5. The assembly of claim 4, wherein each baffle comprises a triangular cross-section.

6. The assembly of claim 2, wherein a threaded aperture is defined through the pedestal.

7. The assembly of claim 6, wherein the base comprises external threads configured to engage the aperture in the pedestal.

8. The assembly of claim 7, wherein when the adjustable atomizer is fully engaged through the deflecting structure, an air gap is maintained between a distal end of the jet and a proximal end of the impact pin.

9. The assembly of claim 8, wherein the adjustable atomizer further comprises a means for adjusting the air gap.

10. The assembly of claim 9, wherein the air gap adjustment means comprises a socket defined in a distal end of the base.

11. The assembly of claim 10, wherein the socket is hexagonal.

12. The assembly of claim 8, wherein the air gap is between about 0.0165 inches to about 0.0175 inches.

13. The assembly of claim 1, wherein an outer diameter of the impact pin is greater than an inner diameter of the jet.

14. The assembly of claim 1, wherein the adjustable atomizer further comprises a means for adjusting placement of the impact pin allowing the proximal end of the impact pin to be positioned upstream, downstream, or coincident with a vena contracta created by the jet.

15. A method for manufacturing a deflecting structure for an atomizing fuel injection assembly having a main body with a first end, a second end and an internal channel extending between the first end and the second end, wherein the first end has a means for connecting the main body to a fuel rail, and wherein a jet is formed in the channel at the second end, the method comprising:
machining a deflecting structure in the second end of the main body and downstream from the jet;
machining internal threads through the deflecting structure; and
forming an adjustable atomizer having a base and an impact pin extending from the base, wherein the base has external threads configured to engage the internal threads of the deflecting structure to provide an adjustable gap between a proximal end of the impact pin and an outlet of the jet.

16. The method of claim 15, wherein machining the deflecting structure comprises machining opposing baffles to extend from the second end toward a pedestal formed at a distal end of the main body, wherein the internal threads are machined through the pedestal.

17. The method of claim 16, wherein the machined baffles partially enclose a channel extending from the jet toward the pedestal, the channel being concentrically aligned with the internal threads.

18. (canceled)

19. The method of claim 18, wherein forming the internal threads and the external threads further allows the adjustable engagement of the adjustable atomizer within the deflecting structure to place the proximal end of the impact pin at a position upstream, downstream, or coincident with a vena contracta of fuel ejected from the jet.

20. The method of claim 15, further comprising forming the impact pin having a proximal end diameter greater than a diameter of an outlet of the jet.
